(19) United States
(12) Patent Application Publication
(10) Pub. No.: US 2026/0026530 A1
(43) Pub. Date: Jan. 29, 2026

(54) PLANT MILK PRODUCTION METHOD

(71) Applicant: AJINOMOTO CO., INC., Tokyo (JP)

(72) Inventors: Akira YOSHIDA, Kawasaki-shi (JP); Masafumi OTA, Kawasaki-shi (JP); Koki KONDO, Kawasaki-shi (JP)

(73) Assignee: AJINOMOTO CO., INC., Tokyo (JP)

(21) Appl. No.: 19/344,023

(22) Filed: Sep. 29, 2025

Related U.S. Application Data
(63) Continuation of application No. PCT/JP2024/013308, filed on Mar. 29, 2024.

(30) Foreign Application Priority Data
Mar. 30, 2023 (JP) 2023-056388

(51) Int. Cl. A23L 7/104; A23C 11/10; A23J 3/14; A23J 3/34; A23L 2/38; A23L 29/00

(52) U.S. Cl. CPC A23L 7/107; A23C 11/10; A23J 3/14; A23J 3/346; A23L 2/38; A23L 29/015; A23L 29/06; A23C 2220/10; C12Y 101/03004; C12Y 203/02013; C12Y 301/01003; C12Y 301/01004; C12Y 302/01004; C12Y 302/01015; C12Y 304/00

(57) ABSTRACT

The present invention aims to provide a method for producing plant-derived milk that can prepare foamed milk having a sufficient amount of air bubbles. In addition, the present invention aims to provide a method for improving dispersion stability of plant-derived milk during production thereof. A method for producing plant-derived milk, or a method for improving dispersion stability of plant-derived milk during production thereof, including treating a raw material containing a plant-derived protein with two or more types of enzymes selected from the group consisting of (1) lipase, (2) glucose oxidase, (3) cell wall degrading enzyme, (4) protease, (5) transglutaminase, and (6) phospholipase (or one or more types of enzymes selected from these and an alkali metal salt). An enzyme preparation for modifying plant-derived milk or for improving dispersion stability of plant-derived milk during production thereof, the preparation containing two or more types of enzymes selected from the group consisting of the (1) to (6) (or one or more types of enzymes selected from these and an alkali metal salt).

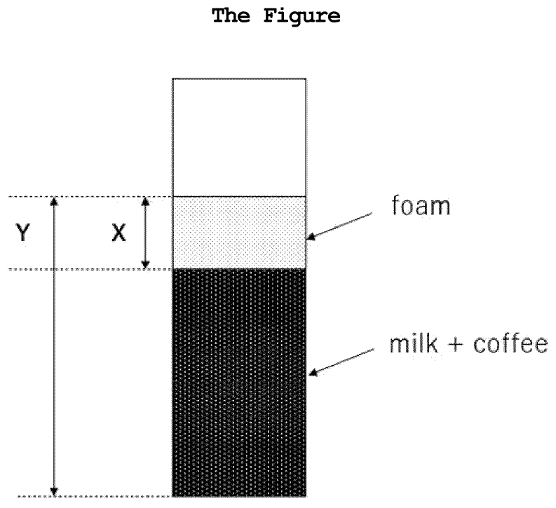

### CROSS-REFERENCE TO RELATED APPLICATIONS

The present application is a Continuation of PCT/JP2024/013308, filed Mar. 29, 2024, which claims priority to JP 2023-056388, filed Mar. 30, 2023, the entire contents of which are incorporated herein by reference.

### TECHNICAL FIELD

The present invention relates to a method for producing plant-derived milk; a method for improving dispersion stability of plant-derived milk during production thereof; and an enzyme preparation for modifying plant-derived milk or for improving dispersion stability of plant-derived milk during production thereof.

### BACKGROUND ART

Foamed milk coffee (also called cafe latte, cappuccino, latte macchiato, etc.) served at restaurants and the like is prepared by combining foamed milk (foam milk) with coffee (or a mixture of coffee and liquid milk), to constitute a layer of foamed milk and a layer of coffee (or a mixture of coffee and liquid milk).

In recent years, the market for dairy-free plant-derived milks (e.g., oat milk) has expanded due to growing awareness of animal welfare and health consciousness. There is a demand for plant-derived milk that can be used to prepare foamed milk.

However, plant-derived milks such as oat milk have poor foamability, making it difficult to produce foamed milk with a sufficient amount of air bubbles.

Furthermore, during the production of plant-derived milks such as oat milk, the oil phase and water phase are prone to separation, or oat-derived sedimentation is likely to occur, making production difficult.

Patent Literature 1 discloses a method for producing plant-derived protein food and drink materials and/or plant-derived protein food and drink products, including a step of treating plant-derived protein food and drink materials and/or plant-derived protein food and drinks with protein deamidase and at least one enzyme selected from the group consisting of lipase and cyclodextrin glucanotransferase.

Patent Literature 2 discloses a method for producing oat milk, using an alkaline protease and an emulsifier.

Patent Literature 3 discloses a method for producing a liquid oat base or drink having an improved soluble oat protein content from an oat material containing starch and oat protein, characterized by solubilizing oat protein in an aqueous solvent, particularly water, by a protein-deamidase means and optionally decanting the product.

However, it was not previously known that the use of the specific enzymes described below in the present invention could produce plant-derived milk capable of producing foamed milk with a sufficient amount of air bubbles. Furthermore, it was not previously known that the use of a specific enzyme described below in the present invention can suppress separation of the oil phase and the aqueous phase or suppress oat-derived precipitation during the production of plant-derived milk (i.e., improve dispersion stability during production).

### CITATION LIST

### Patent Literature

### [Patent Literature 1]

WO 2022/097675

### [Patent Literature 2]

CN 102349579 A

### [Patent Literature 3]

WO 2014/123466

### SUMMARY OF INVENTION

### Technical Problem

An object of the present invention is to provide a method for producing plant-derived milk capable of preparing foamed milk with a sufficient amount of air bubbles. In addition, an object of the present invention is to provide a method for improving dispersion stability of plant-derived milk during production thereof.

### Solution to Problem

The present inventors have conducted intensive studies in an attempt to solve the above-mentioned problems and found that plant-derived milk (e.g., oat milk) that can prepare foamed milk with a sufficient amount of air bubbles can be produced by allowing a specific enzyme in the present invention described below to act on a raw material containing a plant-derived protein (e.g., raw material oats) during the production of the plant-derived milk (e.g., oat milk). The present inventors also found that dispersion stability can be improved by suppressing separation of the oil phase and the aqueous phase or suppressing oat-derived precipitation, by allowing a specific enzyme in the present invention described below to act on a raw material containing a plant-derived protein (e.g., raw material oats) during the production of the plant-derived milk (e.g., oat milk).

Based on these findings, the present inventors have further studied and completed the present invention.

Accordingly, the present invention provides the following.
[1]A method for producing plant-derived milk, comprising treating a raw material containing a plant-derived protein with two or more types of enzymes selected from the group consisting of the following (1) to (6):
   (1) lipase
   (2) glucose oxidase
   (3) cell wall degrading enzyme
   (4) protease
   (5) transglutaminase
   (6) phospholipase.
[2] The production method of the above-mentioned [1], wherein the two or more types of enzymes selected from the group consisting of the aforementioned (1) to (6) are selected from the group consisting of the following (i) to (xx):
   (i) lipase and glucose oxidase
   (ii) lipase and cell wall degrading enzyme
   (iii) lipase and protease
   (iv) glucose oxidase and protease
   (v) cell wall degrading enzyme and protease
   (vi) lipase and transglutaminase
   (vii) lipase and phospholipase
   (viii) glucose oxidase and cell wall degrading enzyme
   (ix) glucose oxidase and transglutaminase
   (x) glucose oxidase and phospholipase
   (xi) two types of cell wall degrading enzymes
   (xii) cell wall degrading enzyme and transglutaminase
   (xiii) cell wall degrading enzyme and phospholipase
   (xiv) two types of proteases
   (xv) protease and phospholipase
   (xvi) protease and transglutaminase
   (xvii) transglutaminase and phospholipase
   (xviii) lipase, cell wall degrading enzyme, and protease
   (xix) lipase and two types of proteases
   (xx) cell wall degrading enzyme, protease, and transglutaminase.
[3] The production method of the above-mentioned [1] or [2], wherein the raw material containing a plant-derived protein is a raw material oat, and the plant-derived milk is oat milk.
[4] The production method of any one of the above-mentioned [1] to [3], wherein the protease is an endo-type protease.
[5] The production method of any one of the above-mentioned [1] to [4], wherein the lipase is a lipase that acts on one or two coordination sites of triglyceride.
[6] The production method of any one of the above-mentioned [1] to [5], wherein the phospholipase is phospholipase A.
[7] The production method of any one of the above-mentioned [1] to [6], wherein the cell wall degrading enzyme is one or more types selected from the group consisting of pectinase, cellulase, and hemicellulase.
[8] The production method of any one of the above-mentioned [1] to [7], further comprising treating with an alkali metal salt.
[9] The production method of the above-mentioned [8], wherein the alkali metal salt is tripotassium phosphate.
[10]A method for producing plant-derived milk, comprising treating a raw material containing a plant-derived protein with one or more types of enzymes selected from the group consisting of the following (1) to (6) and an alkali metal salt: (1) lipase
   (2) glucose oxidase
   (3) cell wall degrading enzyme
   (4) protease
   (5) transglutaminase
   (6) phospholipase.
[11] The production method of the above-mentioned [10], wherein the one or more types of enzymes selected from the group consisting of the aforementioned (1) to (6) are selected from the group consisting of the following (I) to (VI) and (i) to (xx):
   (I) lipase
   (II) glucose oxidase
   (III) cell wall degrading enzyme
   (IV) protease
   (V) transglutaminase
   (VI) phospholipase
   (i) lipase and glucose oxidase
   (ii) lipase and cell wall degrading enzyme
   (iii) lipase and protease
   (iv) glucose oxidase and protease
   (v) cell wall degrading enzyme and protease
   (vi) lipase and transglutaminase
   (vii) lipase and phospholipase
   (viii) glucose oxidase and cell wall degrading enzyme
   (ix) glucose oxidase and transglutaminase
   (x) glucose oxidase and phospholipase
   (xi) two types of cell wall degrading enzymes
   (xii) cell wall degrading enzyme and transglutaminase
   (xiii) cell wall degrading enzyme and phospholipase
   (xiv) two types of proteases
   (xv) protease and phospholipase
   (xvi) protease and transglutaminase
   (xvii) transglutaminase and phospholipase
   (xviii) lipase, cell wall degrading enzyme, and protease
   (xix) lipase and two types of proteases
   (xx) cell wall degrading enzyme, protease, and transglutaminase.
[12] The production method of the above-mentioned [10] or [11], wherein the raw material containing a plant-derived protein is a raw material oat, and the plant-derived milk is oat milk.
[13] The production method of any one of the above-mentioned [10] to [12], wherein the protease is an endo-type protease.
[14] The production method of any one of the above-mentioned [10] to [13], wherein the lipase is a lipase that acts on one or two coordination sites of triglyceride.
[15] The production method of any one of the above-mentioned [10] to [14], wherein the phospholipase is phospholipase A.
[16] The production method of any one of the above-mentioned [10] to [15], wherein the cell wall degrading enzyme is one or more types selected from the group consisting of pectinase, cellulase, and hemicellulase.
[17] The production method of any one of the above-mentioned [10] to [16], wherein the alkali metal salt is tripotassium phosphate.
[17-1] The production method of any one of the above-mentioned [10] to [17], wherein the plant-derived milk is for foamed milk.
[18]A method for improving dispersion stability of plant-derived milk during production thereof, comprising treating a raw material containing a plant-derived protein with two or more types of enzymes selected from the group consisting of the following (1) to (6)
   (1) lipase
   (2) glucose oxidase
   (3) cell wall degrading enzyme
   (4) protease
   (5) transglutaminase
   (6) phospholipase.
[19] The improving method of the above-mentioned [18], wherein the two or more types of enzymes selected from the group consisting of the aforementioned (1) to (6) are selected from the group consisting of the following (i) to (xx):
   (i) lipase and glucose oxidase
   (ii) lipase and cell wall degrading enzyme
   (iii) lipase and protease
   (iv) glucose oxidase and protease
   (v) cell wall degrading enzyme and protease
   (vi) lipase and transglutaminase
   (vii) lipase and phospholipase
   (viii) glucose oxidase and cell wall degrading enzyme
   (ix) glucose oxidase and transglutaminase
   (x) glucose oxidase and phospholipase
   (xi) two types of cell wall degrading enzymes
   (xii) cell wall degrading enzyme and transglutaminase
   (xiii) cell wall degrading enzyme and phospholipase
   (xiv) two types of proteases
   (xv) protease and phospholipase
   (xvi) protease and transglutaminase
   (xvii) transglutaminase and phospholipase
   (xviii) lipase, cell wall degrading enzyme, and protease
   (xix) lipase and two types of proteases
   (xx) cell wall degrading enzyme, protease, and transglutaminase.
[20] The improving method of the above-mentioned [18] or [19], wherein the raw material containing a plant-derived protein is a raw material oat, and the plant-derived milk is oat milk.
[21] The improving method of any one of the above-mentioned [18] to [20], wherein the protease is an endo-type protease.
[22] The improving method of any one of the above-mentioned [18] to [21], wherein the lipase is a lipase that acts on one or two coordination sites of triglyceride.
[23] The improving method of any one of the above-mentioned [18] to [22], wherein the phospholipase is phospholipase A.
[24] The improving method of any one of the above-mentioned [18] to [23], wherein the cell wall degrading enzyme is one or more types selected from the group consisting of pectinase, cellulase, and hemicellulase.
[25] The improving method of any one of the above-mentioned [18] to [24], further comprising treating with an alkali metal salt.
[26] The improving method of the above-mentioned [25], wherein the alkali metal salt is tripotassium phosphate.
[27]A method for improving dispersion stability of plant-derived milk during production thereof, comprising treating a raw material containing a plant-derived protein with one or more types of enzymes selected from the group consisting of the following (1) to (6) and an alkali metal salt:
   (1) lipase
   (2) glucose oxidase
   (3) cell wall degrading enzyme
   (4) protease
   (5) transglutaminase
   (6) phospholipase.
[28] The improving method of the above-mentioned [27], wherein the one or more types of enzymes selected from the group consisting of the aforementioned (1) to (6) are selected from the group consisting of the following (I) to (VI) and (i) to (xx):
   (I) lipase
   (II) glucose oxidase
   (III) cell wall degrading enzyme
   (IV) protease
   (V) transglutaminase
   (VI) phospholipase
   (i) lipase and glucose oxidase
   (ii) lipase and cell wall degrading enzyme
   (iii) lipase and protease
   (iv) glucose oxidase and protease
   (v) cell wall degrading enzyme and protease
   (vi) lipase and transglutaminase
   (vii) lipase and phospholipase
   (viii) glucose oxidase and cell wall degrading enzyme
   (ix) glucose oxidase and transglutaminase
   (x) glucose oxidase and phospholipase
   (xi) two types of cell wall degrading enzymes
   (xii) cell wall degrading enzyme and transglutaminase
   (xiii) cell wall degrading enzyme and phospholipase
   (xiv) two types of proteases
   (xv) protease and phospholipase
   (xvi) protease and transglutaminase
   (xvii) transglutaminase and phospholipase
   (xviii) lipase, cell wall degrading enzyme, and protease
   (xix) lipase and two types of proteases
   (xx) cell wall degrading enzyme, protease, and transglutaminase.
[29] The improving method of the above-mentioned [27] or [28], wherein the raw material containing a plant-derived protein is a raw material oat, and the plant-derived milk is oat milk.
[30] The improving method of any one of the above-mentioned [27] to [29], wherein the protease is an endo-type protease
[31] The improving method of any one of the above-mentioned [27] to [30], wherein the lipase is a lipase that acts on one or two coordination sites of triglyceride.
[32] The improving method of any one of the above-mentioned [27] to [31], wherein the phospholipase is phospholipase A.
[33] The improving method of any one of the above-mentioned [27] to [32], wherein the cell wall degrading enzyme is one or more types selected from the group consisting of pectinase, cellulase, and hemicellulase.
[34] The improving method of any one of the above-mentioned [27] to [33], wherein the alkali metal salt is tripotassium phosphate.
[34-1] The improving method of any one of the above-mentioned [18] to [34], wherein the plant-derived milk is for foamed milk.
[35] An enzyme preparation for modifying plant-derived milk or for improving dispersion stability of plant-derived milk during production thereof, the preparation comprising two or more types of enzymes selected from the group consisting of the following (1) to (6):
   (1) lipase
   (2) glucose oxidase
   (3) cell wall degrading enzyme
   (4) protease
   (5) transglutaminase
   (6) phospholipase.
[36] The enzyme preparation of the above-mentioned [35], wherein the two or more types of enzymes selected from the group consisting of the aforementioned (1) to (6) are selected from the group consisting of the following (i) to (xx):
   (i) lipase and glucose oxidase
   (ii) lipase and cell wall degrading enzyme
   (iii) lipase and protease
   (iv) glucose oxidase and protease
   (v) cell wall degrading enzyme and protease
   (vi) lipase and transglutaminase
   (vii) lipase and phospholipase
   (viii) glucose oxidase and cell wall degrading enzyme
   (ix) glucose oxidase and transglutaminase
   (x) glucose oxidase and phospholipase
   (xi) two types of cell wall degrading enzymes
   (xii) cell wall degrading enzyme and transglutaminase
   (xiii) cell wall degrading enzyme and phospholipase
   (xiv) two types of proteases
   (xv) protease and phospholipase
   (xvi) protease and transglutaminase
   (xvii) transglutaminase and phospholipase
   (xviii) lipase, cell wall degrading enzyme, and protease
   (xix) lipase and two types of proteases
   (xx) cell wall degrading enzyme, protease, and transglutaminase.
[37] The enzyme preparation of the above-mentioned [35] or [36], wherein the plant-derived milk is oat milk.
[38] The enzyme preparation of any one of the above-mentioned [35] to [37], wherein the protease is an endo-type protease.
[39] The enzyme preparation of any one of the above-mentioned [35] to [38], wherein the lipase is a lipase that acts on one or two coordination sites of triglyceride.
[40] The enzyme preparation of any one of the above-mentioned [35] to [39], wherein the phospholipase is phospholipase A.
[41] The enzyme preparation of any one of the above-mentioned [35] to [40], wherein the cell wall degrading enzyme is one or more types selected from the group consisting of pectinase, cellulase, and hemicellulase.
[42] The enzyme preparation of any one of the above-mentioned [35] to [41], further comprising an alkali metal salt.
[43] The enzyme preparation of the above-mentioned [42], wherein the alkali metal salt is tripotassium phosphate.
[44] An enzyme preparation for modifying plant-derived milk or for improving dispersion stability of plant-derived milk during production thereof, the preparation comprising one or more types of enzymes selected from the group consisting of the following (1) to (6), and an alkali metal salt:
   (1) lipase
   (2) glucose oxidase
   (3) cell wall degrading enzyme
   (4) protease
   (5) transglutaminase
   (6) phospholipase.
[45] The enzyme preparation of the above-mentioned [44], wherein the one or more types of enzymes selected from the group consisting of the aforementioned (1) to (6) are selected from the group consisting of the following (I) to (VI) and (i) to (xx):
   (I) lipase
   (II) glucose oxidase
   (III) cell wall degrading enzyme
   (IV) protease
   (V) transglutaminase
   (VI) phospholipase
   (i) lipase and glucose oxidase
   (ii) lipase and cell wall degrading enzyme
   (iii) lipase and protease
   (iv) glucose oxidase and protease
   (v) cell wall degrading enzyme and protease
   (vi) lipase and transglutaminase
   (vii) lipase and phospholipase
   (viii) glucose oxidase and cell wall degrading enzyme
   (ix) glucose oxidase and transglutaminase
   (x) glucose oxidase and phospholipase
   (xi) two types of cell wall degrading enzymes
   (xii) cell wall degrading enzyme and transglutaminase
   (xiii) cell wall degrading enzyme and phospholipase
   (xiv) two types of proteases
   (xv) protease and phospholipase
   (xvi) protease and transglutaminase
   (xvii) transglutaminase and phospholipase
   (xviii) lipase, cell wall degrading enzyme, and protease
   (xix) lipase and two types of proteases
   (xx) cell wall degrading enzyme, protease, and transglutaminase.
[46] The enzyme preparation of the above-mentioned [44] or [45], wherein the plant-derived milk is oat milk.
[47] The enzyme preparation of any one of the above-mentioned [44] to [46], wherein the protease is an endo-type protease.
[48] The enzyme preparation of any one of the above-mentioned [44] to [47], wherein the lipase is a lipase that acts on one or two coordination sites of triglyceride.
[49] The enzyme preparation of any one of the above-mentioned [44] to [48], wherein the phospholipase is phospholipase A.
[50] The enzyme preparation of any one of the above-mentioned [44] to [49], wherein the cell wall degrading enzyme is one or more types selected from the group consisting of pectinase, cellulase, and hemicellulase.
[51] The enzyme preparation of any one of the above-mentioned [44] to [50], wherein the alkali metal salt is tripotassium phosphate.
[51-1] The enzyme preparation of any one of the above-mentioned [35] to [51], wherein the plant-derived milk is for foamed milk.

### Advantageous Effects of Invention

According to the present invention, plant-derived milk (e.g., oat milk) capable of preparing foamed milk having a sufficient amount of air bubbles can be produced. According to the present invention, moreover, dispersion stability can be improved during the production of plant-derived milk (e.g., oat milk).

Plant-derived milk (e.g., oat milk) produced by the production method of the present invention can prepare foamed milk having a sufficient amount of air bubbles.

### BRIEF DESCRIPTION OF DRAWINGS

### [The FIGURE]

The FIGURE is a schematic diagram for explaining the evaluation method of the foamability of oat milk in Experimental Examples 1 to 4.

### DESCRIPTION OF EMBODIMENTS

### 1. Production Method of Plant-Derived Milk

The method for producing plant-derived milk of the present invention includes the following embodiments (A), (B):
(A) a method for producing plant-derived milk, including treating a raw material containing a plant-derived protein with two or more types of enzymes selected from the group consisting of the following (1) to (6) (hereinafter also to be referred to as the production method (A) of the present invention)
(B) a method for producing plant-derived milk, including treating a raw material containing a plant-derived protein with one or more types of enzymes selected from the group consisting of the following (1) to (6) and an alkali metal salt (hereinafter also to be referred to as the production method (B) of the present invention).

In the present specification, unless particularly indicated, “the production method of the present invention” includes the production methods (A) and (B) of the present invention.

The production method (A) of plant-derived milk of the present invention includes treating a raw material containing a plant-derived protein with two or more types of enzymes selected from the group consisting of the following (1) to (6).

The production method (B) of plant-derived milk of the present invention includes treating a raw material containing a plant-derived protein with one or more types of enzymes selected from the group consisting of the following (1) to (6), and an alkali metal salt.
(1) lipase
(2) glucose oxidase
(3) cell wall degrading enzyme
(4) protease
(5) transglutaminase
(6) phospholipase

Examples of the combination of two or more types of enzymes used in the production method of the present invention include the following (7) to (12).
(7) combination of two or more types of proteases (e.g., combination of two or more types selected from the group consisting of chymotrypsin, trypsin, chymotrypsin-like protease, trypsin-like protease, metal protease, and serine protease (e.g., combination of metal protease and serine protease (particularly chymotrypsin-like protease)))
(8) protease and lipase
(9) protease and phospholipase
(10) protease and transglutaminase
(11) protease and cell wall degrading enzyme
(12) lipase and phospholipase

Examples of the combination of two or more types of enzymes used in the production method (A) of the present invention include the following (i) to (xx).
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase

Examples of the combination of one or more types of enzymes (one type of enzyme or combination of two or more types of enzymes) used in the production method (B) of the present invention include the following (I) to (VI) and (i) to (xx).
(I) lipase
(II) glucose oxidase
(III) cell wall degrading enzyme
(IV) protease
(V) transglutaminase
(VI) phospholipase
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase

In the following, the above-mentioned enzymes of (1) to (12), (I) to (VI), (i) to (xx) and the like are also to be collectively referred to as “the enzyme in the present invention”.

### Protease

The protease used in the present invention is an enzyme that catalyzes the hydrolysis of peptide bonds in proteins. In the present invention, any protease with any substrate specificity and any reaction property can be used as long as it has said activity and is capable of degrading proteins. Furthermore, the origin thereof is not particularly limited, and proteases of any origin, such as plant, mammal, fish, or microbial origin, can be used, and recombinant enzymes may also be used.

As the activity unit of endo-type protease in the present invention, the amount of enzyme that causes an increase in the Folin reagent color-developing substance equivalent to 1 μg of tyrosine per minute using casein as a substrate is defined as one unit (1 U).

As the activity unit of exo-type protease in the present invention, the activity that produces 1 μmol of p-nitroaniline per minute using L-leucyl-p-nitroanilide as a substrate is defined as one unit (1 U).

In the production method of the present invention, an endo-type protease is preferably used as the protease.

The endo-type protease used in the present invention is an enzyme that hydrolyzes peptide bonds within proteins to produce several peptides.

The endo-type protease used in the present invention includes, for example, chymotrypsin, trypsin, chymotrypsin-like protease, trypsin-like protease, metalloprotease, serine protease, endo-type neutral protease, and endo-type alkaline protease.

The protease used in the present invention may be a commercially available product, such as Protin SD-NY10 (manufactured by Amano Enzyme Inc., endo-type neutral protease), Protin SD-AY10 (manufactured by Amano Enzyme Inc., endo-type alkaline protease), and Formea CTL 300 BG (manufactured by Novozymes Japan Ltd., chymotrypsin-like protease).

When a protease is used in the production method of the present invention, the amount of protease to be added is preferably 0.0001 to 1000000 U, more preferably 0.001 to 100000 U, further preferably 0.01 to 10000 U, particularly preferably 0.1 to 1000 U, in terms of enzyme activity per 1 g of protein contained in a raw material containing a plant-derived protein (e.g., raw material oat).

### Lipase

The lipase used in the present invention is an enzyme that catalyzes the hydrolysis reaction of fatty acid ester into fatty acid and glycerin. In one preferred embodiment of the present invention, the lipase is a lipase that can be added to foods. Examples of lipase that can be added to foods include, but are not limited to, “Lipase A-10D” (manufactured by Nagase & Co., Ltd.), “Lipase DF ‘Amano’”, “Lipase R” (manufactured by Amano Enzyme Inc.), “Lipase OF”, “Lipase PL” (manufactured by Meito Sangyo Co., Ltd.), and Lipozyme TL 100 L (manufactured by Novozymes Japan Ltd.). In the present specification, the enzyme activity of lipase is defined as follows. That is, 100 ml of olive oil and 150 ml of 2% PVA test solution are emulsified to prepare a substrate, and 5 ml of substrate, 4 ml of McIlvaine buffer (pH 7.0), and 1 ml of enzyme solution are mixed together. The reaction is performed at 37° C. for 60 min, and after the reaction is discontinued, the fatty acid produced is measured by titration. The activity that liberates an acid equivalent to 1 μmol of liberated oleic acid is defined as 1 U (unit).

In the production method of the present invention, the lipase is preferably a lipase that acts on one or two coordination sites of triglyceride.

The lipase used in the present invention may be a commercially available product and, for example, Lipase AY ‘Amano’ 30SD (manufactured by Amano Enzyme Inc.), and Lipase MHA ‘Amano’ 10SD (manufactured by Amano Enzyme Inc.) can be mentioned.

When lipase is used in the production method of the present invention, the amount of lipase to be added is preferably 0.0001 to 10000000 U, more preferably 0.001 to 1000000 U, further preferably 0.01 to 100000 U, particularly preferably 0.1 to 10000 U, in terms of enzyme activity per 1 g of protein contained in a raw material containing a plant-derived protein (e.g., raw material oat).

### Phospholipase

The phospholipase used in the present invention is an enzyme that hydrolyzes phospholipid into fatty acid and other lipophilic substance. Phospholipase A2 is an enzyme that cleaves the SN-2 acyl group of phospholipid. In the present specification, the enzyme activity of phospholipase is defined as follows. When the enzyme is added to a 1% L-α-phosphatidylcholine solution (pH 8.0, 0.1 M Tris-HCl buffer, 5 mM CaCl₂) and reacted at 37° C., the amount of enzyme that produces 1 μmol of free fatty acid per minute is defined as 1 U (1 unit).

In the production method of the present invention, the phospholipase is preferably phospholipase A2.

The phospholipase used in the present invention may be a commercially available product and, for example, PLA2 NAGASE 10P/R (manufactured by Nagase ChemteX Corporation) can be mentioned.

When phospholipase is used in the production method of the present invention, the amount of phospholipase to be added is preferably 0.0001 to 1000000 U, more preferably 0.001 to 100000 U, further preferably 0.01 to 10000 U, particularly preferably 0.1 to 1000 U, in terms of enzyme activity per 1 g of protein contained in a raw material containing a plant-derived protein (e.g., raw material oat).

### Transglutaminase

The transglutaminase used in the present invention is an enzyme that has activity to catalyze the acyl transfer reaction of a glutamine residue in proteins and peptides as donor and a lysine residue as acceptor. Transglutaminases derived from various sources are known, such as those derived from mammals, fish, and microorganisms. Furthermore, the origin of the transglutaminase used in the present invention is not particularly limited as long as it has the aforementioned activity and transglutaminase of any origin can be used, and recombinant enzymes may also be used. The transglutaminase used in the present invention may also be a commercially available product. As a specific example, transglutaminase derived from microorganisms and commercially available from Ajinomoto Co., Inc. under the trade name “Activa” TG can be used alone or in combination.

In the present specification, for the enzymatic activity of transglutaminase, transglutaminase is reacted in a reaction system using benzyloxycarbonyl-L-glutamylglycine and hydroxylamine as substrates in a Tris buffer at 37° C., pH 6.0, the resulting hydroxamic acid is then iron-complexed in the presence of trichloroacetic acid, the absorbance at 525 nm is measured, the amount of hydroxamic acid is determined using a calibration curve, and the amount of enzyme that produces 1 μmol of hydroxamic acid per minute is defined as one unit (1 U) (JP 64-27471 A).

When a transglutaminase is used in the production method of the present invention, the amount of transglutaminase to be added is preferably 0.00001 to 100000 U, more preferably 0.0001 to 10000 U, further preferably 0.001 to 1000 U, particularly preferably 0.01 to 100 U, in terms of enzyme activity per 1 g of protein contained in a raw material containing a plant-derived protein (e.g., raw material oat).

### Cell Wall Degrading Enzyme

The cell wall degrading enzyme used in the present invention refers to enzymes that can act on cell wall components, such as cellulase, hemicellulase, and pectinase.

Cellulase is a cellulose degrading enzyme that randomly hydrolyzes the β-1,4 glycosidic bonds between the β-glucoses that constitute cellulose. A cellulose degrading enzyme produced by any method can be used as long as it has this property. It may be extracted from plants, produced by microorganisms, or may be even a genetically modified enzyme. The enzyme can be in any form, such as powder, liquid, or granule. An example of cellulase used in the present invention is “Cellulase T ‘Amano’ 4” which is commercially available from Amano Enzyme Co., Ltd. Cellulose is the main component constituting cell walls, and cellulase can act to decompose cell walls.

Hemicellulase is a generic term for enzymes that hydrolyze hemicellulose. In one preferred embodiment of the present invention, the hemicellulase is a hemicellulase that can be added to foods. Examples of hemicellulase that can be added to foods include, but are not limited to, “Hemicellulase ‘Amano’ 90” (manufactured by Amano Enzyme Inc.), “Sumizyme X” (manufactured by Shin-Nihon Chemical Co., Ltd.), and the like.

As the enzyme activity of cellulase in the present specification, the amount of enzyme that increases the reducing power equivalent to 1 μmol of glucose per minute using carmellose sodium as a substrate was defined as 1 U (unit). As the enzyme activity of hemicellulase, the amount of enzyme that produces reducing sugars equivalent to 1 mg of xylose per minute using xylan as a substrate was defined as 100 U (unit).

Pectinase is an enzyme that has the activity of catalyzing the hydrolysis of pectin (EC 3.2.1.15, etc.). This activity is also referred to as “pectinase activity”. Specifically, pectinase activity may be the activity of catalyzing the hydrolysis of the α-1,4 glycosidic bond in the polygalacturonic acid chain that constitutes pectin. The “pectinase activity” also includes pectin lyase activity, which degrades polygalacturonic acid chains by β elimination, pectin methylesterase activity, which demethylates the methyl ester group of pectin, and protopectinase activity, which acts on water-insoluble protopectin to liberate water-soluble pectin.

In the present specification, the enzymatic activity of pectinase can be measured by the following procedure. That is, pectinase activity can be measured by incubating the enzyme with a substrate and measuring the enzyme-dependent decomposition of the substrate. Substrate decomposition can be measured, for example, using the generation of reducing ends (i.e., an increase in reducing power) as an indicator. The increase in reducing power can be measured, for example, by the dinitrosalicylic acid (DNS) method or the Somogyi-Nelson method. In the case of pectinase, the amount of enzyme that increases the reducing power equivalent to 1 μmol of galacturonic acid per minute at 45° C. and pH 4.5 when enzyme reaction is performed using polygalacturonic acid as a substrate is defined as 1 U (unit). In the case of pectinase, an increase in reducing power equivalent to a certain amount of galacturonic acid can also be interpreted as the production of that amount of galacturonic acid. The amount of galacturonic acid produced can be measured using known methods used for quantifying compounds, such as HPLC, LC/MS, GC/MS, and NMR.

In the production method of the present invention, the cell wall degrading enzyme is preferably pectinase, cellulase, or hemicellulase, more preferably pectinase.

The cell wall degrading enzyme used in the present invention may be a commercially available product and, for example, Cellulase A ‘Amano’ 3 (manufactured by Amano Enzyme Inc.), Hemicellulase ‘Amano’ 90 (manufactured by Amano Enzyme Inc.), Pectinase XP-534 NEO (manufactured by Nagase ChemteX Corporation), and Sumizyme AP2 (manufactured by Shin-Nihon Chemical Co., Ltd.) can be mentioned.

When a cell wall degrading enzyme is used in the production method of the present invention, the amount of the cell wall degrading enzyme to be added is preferably 0.00001 to 1000000 U, more preferably 0.00001 to 100000 U, further preferably 0.0001 to 10000 U, particularly preferably 0.001 to 1000 U, in terms of enzyme activity per 1 g of protein contained in a raw material containing a plant-derived protein (e.g., raw material oat).

When cellulase is used in the production method of the present invention, the amount of cellulase to be added is preferably 0.00001 to 100000 U, more preferably 0.0001 to 10000 U, further preferably 0.001 to 1000 U, particularly preferably 0.01 to 100 U, in terms of enzyme activity per 1 g of protein contained in a raw material containing a plant-derived protein (e.g., raw material oat).

When hemicellulase is used in the production method of the present invention, the amount of hemicellulase to be added is preferably 0.00001 to 100000 U, more preferably 0.0001 to 10000 U, further preferably 0.001 to 1000 U, particularly preferably 0.01 to 100 U, in terms of enzyme activity per 1 g of protein contained in a raw material containing a plant-derived protein (e.g., raw material oat).

When pectinase is used in the production method of the present invention, the amount of pectinase to be added is preferably 0.00001 to 100000 U, more preferably 0.0001 to 10000 U, further preferably 0.001 to 1000 U, particularly preferably 0.01 to 100 U, in terms of enzyme activity per 1 g of protein contained in a raw material containing a plant-derived protein (e.g., raw material oat).

### Glucose Oxidase

The glucose oxidase used in the present invention is an enzyme that catalyzes the reaction using glucose and oxygen as substrates to produce gluconolactone (gluconolactone is non-enzymatically hydrolyzed to gluconic acid) and hydrogen peroxide. The hydrogen peroxide produced by this reaction oxidizes SH group in proteins, promoting the formation of disulfide bonds (SS bonds) and forming crosslinked structures in the proteins. Glucose oxidase is known to originate from a variety of sources, including microorganisms such as koji mold and plants. Any of these glucose oxidases may be used, and there are no limitations on their origin. Also, recombinant enzymes may also be used. A specific example of glucose oxidase is the microbial glucose oxidase commercially available from Shin-Nihon Chemical Co., Ltd. under the trade name “Sumizyme PGO”.

In the present invention, as the activity unit of glucose oxidase, the amount of enzyme that oxidizes 1 μmol of glucose per minute at 37° C., pH 7.0 is defined as 1 U (unit).

In the present invention, the activity of glucose oxidase can be measured as follows. Using glucose as a substrate, glucose oxidase is reacted in the presence of oxygen to generate hydrogen peroxide. The generated hydrogen peroxide is reacted with peroxidase in the presence of aminoantipyrine and phenol to generate a quinoneimine dye. The generated quinoneimine dye is measured at a wavelength of 500 nm. Specifically, it is as follows. Glucose oxidase is dissolved in 0.1 mol/L phosphate buffer (potassium dihydrogen phosphate, adjusted to pH 7.0 with aqueous sodium hydroxide) by stirring, and then diluted 50-fold with 0.1 mol/L phosphate buffer to prepare a GO solution. To an analytical cell, 2.0 mL of a phenol-containing buffer solution (Milli-Q, mixture of 1.36 g of potassium dihydrogen phosphate, 3 mL of 5% phenol test solution, and 3 mL of 5% Triton X-100 solution, adjusted to pH 7.0, 100 mL with aqueous sodium hydroxide), 500 μL of a 10% glucose solution, 500 μL of a 0.01% peroxidase solution (PO ‘Amano’ 3 (1250 U±250 U)), and 100 μL of a 0.4% 4-aminoantipyrine solution were added in this order, and the mixture is then mixed by inversion and retained at 37±0.1° C. for 10 min. 100 μL of the GO solution is placed in the above-mentioned analysis cell, and measurements are automatically performed at 11 points every 30 seconds for 5 min. GO activity is calculated from the increment (slope) between 120 and 300 seconds. For the blank group, the value measured above is obtained by adding 0.1 mol/L phosphate buffer instead of GO solution, and this value is subtracted from the GO test plot. For oxidative-reductases other than glucose oxidase, the amount of enzyme required to oxidize or reduce 1 μmol of substrate per minute is defined as 1 U (unit).

When glucose oxidase is used in the production method of the present invention, the amount of glucose oxidase to be added is, for example, 0.00001 to 100000 U, preferably 0.0001 to 10000 U, more preferably 0.001 to 1000 U, further preferably 0.01 to 100 U, in terms of enzyme activity per 1 g of starch contained in a raw material containing a plant-derived protein (e.g., raw material oat).

### (i) Lipase and Glucose Oxidase

When lipase and glucose oxidase are used in combination in the production method of the present invention, the weight ratio of the amounts to be added (lipase:glucose oxidase) is, for example, 1:0.00001 to 100000, preferably 1:0.0001 to 10000, more preferably 1:0.001 to 1000, further preferably 1:0.01 to 100.

### (ii) Lipase and Cell Wall Degrading Enzyme

When lipase and a cell wall degrading enzyme (e.g., cellulase, hemicellulase, pectinase) are used in combination in the production method of the present invention, the weight ratio of the amounts to be added (lipase:cell wall degrading enzyme) is, for example, 1:0.00001 to 100000, preferably 1:0.0001 to 10000, more preferably 1:0.001 to 1000, further preferably 1:0.01 to 100.

(iii) Lipase and Protease

When lipase and protease are used in combination in the production method of the present invention, the weight ratio of the amounts to be added (lipase:protease) is, for example, 1:0.00001 to 100000, preferably 1:0.0001 to 10000, more preferably 1:0.001 to 1000, further preferably 1:0.01 to 100.

### (iv) Glucose Oxidase and Protease

When glucose oxidase and protease are used in combination in the production method of the present invention, the weight ratio of the amounts to be added (glucose oxidase:protease) is, for example, 1:0.00001 to 100000, preferably 1:0.0001 to 10000, more preferably 1:0.001 to 1000, further preferably 1:0.01 to 100.

### (v) Cell Wall Degrading Enzyme and Protease

When a cell wall degrading enzyme (e.g., cellulase, hemicellulase, pectinase) and protease are used in combination in the production method of the present invention, the weight ratio of the amounts to be added (cell wall degrading enzyme:protease) is, for example, 1:0.00001 to 100000, preferably 1:0.0001 to 10000, more preferably 1:0.001 to 1000, further preferably 1:0.01 to 100.

### (vi) Lipase and Transglutaminase

When lipase and transglutaminase are used in combination in the production method of the present invention, the weight ratio of the amounts to be added (lipase:transglutaminase) is, for example, 1:0.00001 to 100000, preferably 1:0.0001 to 10000, more preferably 1:0.001 to 1000, further preferably 1:0.01 to 100.

(vii) Lipase and Phospholipase

When lipase and phospholipase are used in combination in the production method of the present invention, the weight ratio of the amounts to be added (lipase:phospholipase) is, for example, 1:0.00001 to 100000, preferably 1:0.0001 to 10000, more preferably 1:0.001 to 1000, further preferably 1:0.01 to 100.

(viii) Glucose Oxidase and Cell Wall Degrading Enzyme

When glucose oxidase and a cell wall degrading enzyme (e.g., cellulase, hemicellulase, pectinase) are used in combination in the production method of the present invention, the weight ratio of the amounts to be added (glucose oxidase:cell wall degrading enzyme) is, for example, 1:0.00001 to 100000, preferably 1:0.0001 to 10000, more preferably 1:0.001 to 1000, further preferably 1:0.01 to 100.

### (ix) Glucose Oxidase and Transglutaminase

When glucose oxidase and transglutaminase are used in combination in the production method of the present invention, the weight ratio of the amounts to be added (glucose oxidase:transglutaminase) is, for example, 1:0.00001 to 100000, preferably 1:0.0001 to 10000, more preferably 1:0.001 to 1000, further preferably 1:0.01 to 100.

### (x) Glucose Oxidase and Phospholipase

When glucose oxidase and phospholipase are used in combination in the production method of the present invention, the weight ratio of the amounts to be added (glucose oxidase:phospholipase) is, for example, 1:0.00001 to 100000, preferably 1:0.0001 to 10000, more preferably 1:0.001 to 1000, further preferably 1:0.01 to 100.

### (xi) Two Types of Cell Wall Degrading Enzymes

When two types of cell wall degrading enzymes (pectinase and cellulase) are used in combination in the production method of the present invention, the weight ratio of the amounts to be added (cell wall degrading enzyme (pectinase):cell wall degrading enzyme (cellulase)) is, for example, 1:0.00001 to 100000, preferably 1:0.0001 to 10000, more preferably 1:0.001 to 1000, further preferably 1:0.01 to 100.

When two types of cell wall degrading enzymes (pectinase and hemicellulase) are used in combination in the production method of the present invention, the weight ratio of the amounts to be added (cell wall degrading enzyme (pectinase):cell wall degrading enzyme (hemicellulase)) is, for example, 1:0.00001 to 100000, preferably 1:0.0001 to 10000, more preferably 1:0.001 to 1000, further preferably 1:0.01 to 100.

(xii) Cell Wall Degrading Enzyme and Transglutaminase

When a cell wall degrading enzyme (e.g., cellulase, hemicellulase, pectinase) and transglutaminase are used in combination in the production method of the present invention, the weight ratio of the amounts to be added (cell wall degrading enzyre:transglutaminase) is, for example, 1:0.0001 to 10000, preferably 1:0.001 to 1000, more preferably 1:0.01 to 100, further preferably 1:0.1 to 10.

(xiii) Cell Wall Degrading Enzyme and Phospholipase

When a cell wall degrading enzyme (e.g., cellulase, hemicellulase, pectinase) and phospholipase are used in combination in the production method of the present invention, the weight ratio of the amounts to be added (cell wall degrading enzyme:phospholipase) is, for example, 1:0.0001 to 10000, preferably 1:0.001 to 1000, more preferably 1:0.01 to 100, further preferably 1:0.1 to 10.

(xiv) Two Types of Proteases

When two types of proteases (e.g., endo-type neutral protease (Protin SD-NY10) and chymotrypsin-like protease (Formea CTL 300 BG)) are used in combination in the production method of the present invention, the weight ratio of the amounts to be added (endo-type neutral protease (Protin SD-NY10):chymotrypsin-like protease (Formea CTL 300 BG)) is, for example, 1:0.00001 to 100000, preferably 1:0.0001 to 10000, more preferably 1:0.001 to 1000, further preferably 1:0.01 to 100.

### (xv) Protease and Phospholipase

When protease and phospholipase are used in combination in the production method of the present invention, the weight ratio of the amounts to be added (protease:phospholipase) is, for example, 1:0.00001 to 100000, preferably 1:0.0001 to 10000, more preferably 1:0.001 to 1000, further preferably 1:0.01 to 100.

(xvi) Protease and Transglutaminase

When protease and transglutaminase are used in combination in the production method of the present invention, the weight ratio of the amounts to be added (protease:transglutaminase) is, for example, 1:0.00001 to 100000, preferably 1:0.0001 to 10000, more preferably 1:0.001 to 1000, further preferably 1:0.01 to 100.

(xvii) Transglutaminase and Phospholipase

When transglutaminase and phospholipase are used in combination in the production method of the present invention, the weight ratio of the amounts to be added (transglutaminase:phospholipase) is, for example, 1:0.00001 to 100000, preferably 1:0.0001 to 10000, more preferably 1:0.001 to 1000, further preferably 1:0.01 to 100.

(xviii) Lipase, Cell Wall Degrading Enzyme, and Protease

When lipase, a cell wall degrading enzyme (e.g., cellulase, hemicellulase, pectinase), and protease are used in combination in the production method of the present invention, the weight ratio of the amounts to be added (lipase:cell wall degrading enzyme:protease) is, for example, 1:0.00001 to 100000:0.00001 to 100000, preferably 1:0.0001 to 10000:0.0001 to 10000, more preferably 1:0.001 to 1000:0.001 to 1000, further preferably 1:0.01 to 100:0.01 to 100.

(xix) Lipase and Two Types of Proteases

When lipase and two types of proteases (e.g., chymotrypsin-like protease (Formea CTL 300 BG) and endo-type alkaline protease (Protin SD-AY10)) are used in combination in the production method of the present invention, the weight ratio of the amounts to be added (lipase:chymotrypsin-like protease (Formea CTL 300 BG):endo-type alkaline protease protease (Protin SD-AY10)) is, for example, 1:0.00001 to 100000:0.00001 to 100000, preferably 1:0.0001 to 10000:0.0001 to 10000, more preferably 1:0.001 to 1000:0.001 to 1000, further preferably:0.01 to 100:0.01 to 100.

### (xx) Cell Wall Degrading Enzyme, Protease, and Transglutaminase

When a cell wall degrading enzyme (e.g., cellulase, hemicellulase, pectinase), protease, and transglutaminase are used in combination in the production method of the present invention, the weight ratio of the amounts to be added (cell wall degrading enzyre:protease:transglutaminase) is, for example, 1:0.00001 to 100000:0.00001 to 100000, preferably 1:0.0001 to 10000:0.0001 to 10000, more preferably 1:0.001 to 1000:0.001 to 1000, further preferably:0.01 to 100:0.01 to 100.

In the present invention, the raw material containing a plant-derived protein to be treated with the enzyme may be plants or processed products thereof that are conventionally used as raw materials for plant-derived milks. Examples include grains such as oats and rice, nuts such as almond, cashew, and coconut, pulses such as soybean and pea, and processed products of these. The aforementioned grains, nuts, and pulses may be whole grains, or may have the outer skin and germ removed, or may be ground, and ground grains are preferred. Examples of the processed products of the aforementioned grains, nuts, and pulses include plant-derived milk (e.g., oat milk powder) produced by conventional production methods.

In the present invention, commercially available products can also be used as the raw material containing a plant-derived protein. Examples include the trade name “Oat Flour” which is whole oat flour (manufactured in Denmark/Sansho Co., Ltd.) and the trade name “Oat Milk Powder GD-F” (Godo Co., Ltd.) which is oat milk powder produced by conventional production methods.

In the present invention, oat milk can be produced by using raw materials derived from oats (e.g., whole oats, oats with the outer skin and germ removed, ground oats, or processed products) (referred to as “raw material oat” in the present specification) as a raw material containing a plant-derived protein to be treated with enzymes.

The production method of the present invention can be performed using the same raw materials and the same method as for general plant-derived milks, except for the treatment with the enzyme in the present invention.

For example, the production method of the present invention can produce the plant-derived milk of the present invention (e.g., oat milk) by the following steps:
(i) a raw material containing a plant-derived protein (e.g., raw material oats) is mixed with water (where necessary, the raw material is ground in a mill or the like and mixed with water, or the raw material is ground in a mill or the like together with water) to obtain a 1-30 w/w % suspension.
(ii) 0.1-1000 U of α-amylase and 0.001-100 U of β-amylase per gram of starch contained in the raw material containing the plant-derived protein (e.g., raw material oats) are added to the obtained suspension, and the mixture is reacted at 20-80° C. for 0.5-10 hr. The pH of the reaction solution is adjusted to 6-10 using a pH adjuster (e.g., tripotassium phosphate).
(iii) After adjusting the pH in (ii), the enzyme in the present invention is added and reacted at 20 to 80° C. for 0.5 to 10 hr.
(iv) After completion of the reaction in (iii), the mixture is heated at 90 to 100° C. for 1 to 30 min to inactivate the enzyme.
(v) The solid-liquid separation is performed by centrifugation or the like, the liquid is recovered, and the pH is adjusted to 6-10 using a pH adjuster (e.g., tripotassium phosphate) where necessary to obtain the plant-derived milk (e.g., oat milk) of the present invention.

When multiple enzymes are added, the order of addition may be any, and they may be added all at once or sequentially with time difference.

In production method (A) of the present invention, it is preferable to further add an alkali metal salt (e.g., tripotassium phosphate). The addition of the alkali metal salt is expected to improve the foamability of the plant-derived milk (e.g., oat milk).

The production method (B) of the present invention includes treating the above-mentioned raw materials with the above-mentioned one or more types of enzymes and an alkali metal salt (e.g., tripotassium phosphate). The addition of the alkali metal salt is expected to have the effect of improving the foamability of the plant-derived milk (e.g., oat milk).

In the production method of the present invention, the addition of alkali metal salt is not particularly limited and can be added during dispersion of the raw material containing a plant-derived protein (e.g., raw material oats), during addition of amylase, during addition of enzyme, or at the end of the enzyme reaction.

In the production method of the present invention, the amount of alkali metal salt to be added is preferably 0.00001 w/w % to 10.0 w/w %, more preferably 0.0001 w/w % to 5.0 w/w %, further preferably 0.001 w/w % to 1.0 w/w %, particularly preferably 0.01 w/w % to 0.1 w/w %, based on the total weight (raw material containing a plant-derived protein+dissolution water).

When an alkali metal salt (e.g., tripotassium phosphate) is used as a pH adjuster, the alkali metal salt only needs to be added within the above range, and further addition of alkali metal salt is not necessary.

Modified plant-derived milk (e.g., oat milk) can be produced by the production method of the present invention.

In the present specification, “modified” includes improved foamability.

The presence or absence of modification (improvement of foamability) can be evaluated in accordance with the evaluation of foamability in the below-mentioned Experimental Examples.

Since the modified plant-derived milk (e.g., oat milk) produced by the production method of the present invention is superior in foamability, it is useful as a plant-derived milk for preparing foamed milk (also to be referred to as “plant-derived milk for foamed milk” in the present specification).

The modified plant-derived milk (e.g., oat milk) produced by the production method of the present invention can also be used as plant milk to be mixed with coffee and used to prepare a coffee drinks (also to be referred to as “plant-derived milk for coffee drinks” in the present specification).

In the present invention, “coffee drinks” may be any drink that contains a combination of coffee and plant-derived milk, and includes, for example, foamed milk coffee (also known as cafe latte, cappuccino, latte macchiato, etc.), which is prepared to have a layer of foamed plant-derived milk and a layer of coffee (or a mixture of coffee and liquid plant-derived milk), and coffee with plant-derived milk, which is prepared by mixing liquid plant-derived milk with coffee.

### 2. Method for Improving Dispersion Stability of Plant-Derived Milk During Production Thereof

The present invention also relates to a method for improving dispersion stability of plant-derived milk during production thereof, including treating a raw material containing a plant-derived protein with the above-mentioned enzyme in the present invention (hereinafter to be also simply referred to as the method for improving dispersion stability of the present invention).

The method for improving dispersion stability of the present invention includes the following embodiments (A), (B).
(A) A method for improving dispersion stability of plant-derived milk during production thereof, comprising treating a raw material containing a plant-derived protein with two or more types of enzymes selected from the group consisting of the above-mentioned (1) to (6) (hereinafter also to be referred to as the improving method (A) of the present invention).
(B) A method for improving dispersion stability of plant-derived milk during production thereof, comprising treating a raw material containing a plant-derived protein with one or more types of enzymes selected from the group consisting of the above-mentioned (1) to (6) and an alkali metal salt (hereinafter also to be referred to as the improving method (B) of the present invention).

In the present specification, unless particularly indicated, “the improving method of the present invention” includes the improving methods (A) and (B) of the present invention.

In the present specification, “improving dispersion stability” means that phase separation (separation of oil phase and water phase, or oat-derived precipitation, etc.) is suppressed during the production of plant-derived milk.

The presence or absence of improvement of dispersion stability can be evaluated in accordance with the evaluation of dispersion stability in the below-mentioned Experimental Examples.

In the method for improving dispersion stability of the present invention, the definition, amount to be added, and method of addition (action time, action temperature, and method for terminating the enzymatic reaction) of each enzyme in the present invention, examples of raw materials containing plant-derived proteins to be treated with the enzyme, examples of alkali metal salts, and amounts to be added are the same as the definition, amount to be added, and method of addition (action time, action temperature, and method for terminating the enzymatic reaction) of each enzyme in the present invention, examples of raw materials containing plant-derived proteins to be treated with the enzyme, examples of alkali metal salts, and amounts to be added in the production method of the present invention.

### 3. Enzyme Preparation for Modifying Plant-Derived Milk or for Improving Dispersion Stability of Plant-Derived Milk During Production Thereof

The present invention also relates to an enzyme preparation for modifying plant-derived milk or for improving dispersion stability of plant-derived milk during production thereof, which contains the above-mentioned enzyme in the present invention (hereinafter to be also simply referred to as the enzyme preparation of the present invention).

The enzyme preparation of the present invention includes the following embodiments (A), (B).
(A) An enzyme preparation for modifying plant-derived milk or for improving dispersion stability of plant-derived milk during production thereof, the preparation comprising two or more types of enzymes selected from the group consisting of the above-mentioned (1) to (6) (hereinafter also to be referred to as the enzyme preparation (A) of the present invention).
(B) An enzyme preparation for modifying plant-derived milk or for improving dispersion stability of plant-derived milk during production thereof, the preparation comprising one or more types of enzymes selected from the group consisting of the above-mentioned (1) to (6), and an alkali metal salt (hereinafter also to be referred to as the enzyme preparation (B) of the present invention).

In the present specification, unless particularly indicated, “the enzyme preparation of the present invention” includes the enzyme preparations (A) and (B) of the present invention.

In the enzyme preparation of the present invention, the definition, amount to be added, and method of addition (action time, action temperature, and method for terminating the enzymatic reaction) of each enzyme in the present invention, examples of raw materials containing plant-derived proteins to be treated with the enzyme, examples of alkali metal salts, and amounts to be added are the same as the definition, amount to be added, and method of addition (action time, action temperature, and method for terminating the enzymatic reaction) of each enzyme in the present invention, examples of raw materials containing plant-derived proteins to be treated with the enzyme, examples of alkali metal salts, and amounts to be added in the production method or method for improving dispersion stability of the present invention.

The enzyme preparation of the present invention can be added to a raw material containing a plant-derived protein (e.g., raw material oat) and reacted in accordance with the method and amount of addition of the enzyme (or oxygen and alkali metal salt) of the above-mentioned production method of the present invention, to produce a modified plant-derived milk (e.g., oat milk). In addition, the enzyme preparation of the present invention can be used in the method for improving dispersion stability of the present invention.

The present invention is explained in more detail in the following by referring to Examples and Experimental Examples; however, the present invention is not limited by these Examples and Experimental Examples.

### EXAMPLE

In the following Examples and Comparative Examples, the enzymes shown in Tables 1-1, 1-2 were used.

TABLE 1-1

| enzyme type | trade name | company name |
|---|---|---|
| protease | Protin SD-AY10 | Amano Enzyme Inc. |
| protease | Protin SD-NY10 | Amano Enzyme Inc. |
| protease | Formea CTL 300 BG | Novozymes Japan Ltd. |
| lipase | Lipozyme TL 100 L | Novozymes Japan Ltd. |
| lipase | Lipase AY ‘Amano’ 30SD | Amano Enzyme Inc. |
| lipase | Lipase MHA ‘Amano’ 10SD | Amano Enzyme Inc. |
| cellulase | Cellulase A ‘Amano’ 3 | Amano Enzyme Inc. |
| hemicellulase | Hemicellulase ‘Amano’ 90 | Amano Enzyme Inc. |
| phospholipase A2 | PLA2 NAGASE 10P/R | Nagase ChemteX |
| | | Corporation |
| transglutaminase | Activa TG | Amano Enzyme Inc. |

TABLE 1-2

| enzyme type | trade name | company name |
|---|---|---|
| pectinase | Pectinase | Nagase ChemteX |
| | XP-534 NEO | Corporation |
| pectinase | Sumizyme AP2 | Shin-Nihon Chemical Co., Ltd. |
| glucose oxidase | Sumizyme PGO | Shin-Nihon Chemical Co., Ltd. |

### [Experimental Example 1] Study on Oat Milk Foamability Improving Effect by Enzyme Addition

### (Production of Oat Milks of Examples 1 to 16)

Oat milk powder (trade name: Oat Milk Powder GD-F, Godo Co., Ltd.) was mixed with water to obtain a 20 w/w % oat milk powder suspension. To the obtained suspension was added α-amylase (trade name: Spitase CP-40FG, Nagase ChemteX Corporation) at 170 U/g of starch, and β-amylase (trade name: β-Amylase-F ‘Amano’, Amano Enzyme Inc.) was added at 0.09 U/g of starch, and the mixture was reacted at 60° C. for 1 hr. After completion of the reaction, the pH of the reaction solution was adjusted to 8 using tripotassium phosphate. Thereafter, each enzyme listed in Tables 2 and 3 was added at the concentrations listed in Tables 2 and 3, and the mixture was reacted at 60° C. for 1 hr. After completion of the reaction, the mixture was heated at 95° C. for 10 min and then cooled. The cooled suspension was centrifuged at 1000 G/1 min to separate the solid from the liquid, and only the liquid was recovered. The pH was adjusted to 7.5 using tripotassium phosphate, and the oat milks of Examples 1 to 16 were obtained.

### (Production of Oat Milk of Comparative Example 1)

The oat milk of Comparative Example 1 was obtained in the same manner as in Examples 1 to 16, except that the enzymes shown in Tables 2 and 3 were not added.

For Examples 1 to 16 and Comparative Example 1, the total amount of tripotassium phosphate used for the above-mentioned pH adjustment is shown in Tables 2 and 3.

### (Confirmation of Foamability of Oat Milk)

(Test Method) The oat milks obtained in Examples 1 to 16, Comparative Example 1 were heated to 60° C., and 30 g was weighed and poured into a milk foamer (trade name: Milk Cup Foamer MCF30W, UCC Ueshima Coffee Co., Ltd.). It was foamed for 3 min to create air bubbles.

Immediately after foaming was completed, the entire amount, including the foam and liquid oat milk, was added to a glass cup containing 70 g of coffee, forming a foam layer of oat milk on top of the liquid layer consisting of a mixture of coffee and liquid oat milk. The height of the entire amount (i.e., from the bottom of the liquid layer to the top of the foam layer (Y in The FIGURE)) and the height of the foam layer (i.e., from the boundary between the liquid layer and the foam layer to the top of the foam layer (X in The FIGURE)) were measured, and the ratio of the foam layer was calculated according to the following formula. The foamability evaluation for each Example is shown in Tables 4 and 5 as a relative value, when the ratio of the foam layer in Comparative Example 1 was set to 100.

### (Formula for Calculating Ratio of Foam Layer)

$$Ratio of foam layer = height of foam layer ( X ) / height of entire amount ( Y )$$

TABLE 2
blended amount

| | | Comp. | | | | | | | | | | |
|---|---|---|---|---|---|---|---|---|---|---|---|---|
| | | Ex. | Ex. | Ex. | Ex. | Ex. | Ex. | Ex. | Ex. | Ex. | Ex. | Ex. |
| | | 1 | 1 | 2 | 3 | 4 | 5 | 6 | 7 | 8 | 9 | 10 |
| enzyme | protease (Protin SD-AY10) | | 0.02 | | | | | | | | | |
| | | | (*1) | | | | | | | | | |
| | protease (Protin SD-NY10) | | | 0.001 | | | | | | | | |
| | | | | (*1) | | | | | | | | |
| | protease (Formea CTL 300 BG) | | | | 0.11 | | | | | | | |
| | | | | | (*1) | | | | | | | |
| | lipase (Lipozyme TL 100 L) | | | | | 0.007 | | | | | | |
| | | | | | | (*2) | | | | | | |
| | lipase (Lipase AY ‘Amano’ | | | | | | 0.001 | | | | | |
| | 30SD) | | | | | | (*2) | | | | | |
| | lipase (Lipase MHA ‘Amano’ | | | | | | | 0.001 | | | | |
| | 10SD) | | | | | | | (*2) | | | | |
| | cellulase (Cellulase A | | | | | | | | 0.00001 | | | |
| | ‘Amano’ 3) | | | | | | | | (*2) | | | |
| | hemicellulase (Hemicellulase | | | | | | | | | 0.00001 | | |
| | ‘Amano’ 90) | | | | | | | | | (*2) | | |
| | phospholipase (PLA2 NAGASE | | | | | | | | | | 0.00001 | |
| | 10P/R) | | | | | | | | | | (*2) | |
| | transglutaminase (Activa TG) | | | | | | | | | | | 0.11 |
| | | | | | | | | | | | | (*1) |
| alkali | tripotassium phosphate | 0.1 | 0.1 | 0.1 | 0.1 | 0.1 | 0.1 | 0.1 | 0.1 | 0.1 | 0.1 | 0.1 |
| metal | | | | | | | | | | | | |
| salt | | | | | | | | | | | | |

(*1): The numerical values indicate wt/wt% to weight of protein in oat milk powder.
(*2): The numerical values indicate wt/wt% to the total weight of the system (oat milk powder + dissolution water).

TABLE 3
blended amount (wt/wt %)

| | | Ex. | Ex. | Ex. | Ex. | Ex. | Ex. |
|---|---|---|---|---|---|---|---|
| | | 11 | 12 | 13 | 14 | 15 | 16 |
| enzyme | protease (Protin | 0.001 | | | 0.001 | | |
| | SD-NY10) | | | | | | |
| | protease (Formea | 0.0004 | 0.001 | 0.001 | | 0.0004 | |
| | CTL 300 BG) | | | | | | |
| | lipase (Lipase | | 0.001 | | | | 0.001 |
| | MHA ‘Amano’ 10SD) | | | | | | |
| | phospholipase | | | 0.00001 | | | 0.00001 |
| | (PLA2 NAGASE | | | | | | |
| | 10P/R) | | | | | | |
| | cellulase | | | | 0.001 | | |
| | (Cellulase A | | | | | | |
| | ‘Amano’ 3) | | | | | | |
| | transglutaminase | | | | | 0.0008 | |
| | (Activa TG) | | | | | | |
| alkali | tripotassium | 0.1 | 0.1 | 0.1 | 0.1 | 0.1 | 0.1 |
| metal | phosphate | | | | | | |
| salt | | | | | | | |

In Table, numerical values indicate wt/wt % to the total weight of the system (oat milk powder + dissolution water).

TABLE 4

| | Comp. | | | | | | | | | | |
|---|---|---|---|---|---|---|---|---|---|---|---|
| | Ex. | Ex. | Ex. | Ex. | Ex. | Ex. | Ex. | Ex. | Ex. | Ex. | Ex. |
| | 1 | 1 | 2 | 3 | 4 | 5 | 6 | 7 | 8 | 9 | 10 |
| foamability | 100 | 149.4 | 111.7 | 145.8 | 115.7 | 144 | 130.3 | 135.2 | 120 | 112.6 | 124.4 |
| (*1) | | | | | | | | | | | |

(*1): Numerical values of foamability indicate relative values to the results of Comparative Example 1 as 100.

TABLE 5

| | Ex. | Ex. | Ex. | Ex. | Ex. | Ex. |
|---|---|---|---|---|---|---|
| | 11 | 12 | 13 | 14 | 15 | 16 |
| foamability | 168.8 | 168.8 | 168.8 | 168.8 | 135.5 | 130.3 |
| (*1) | | | | | | |

(*1): In Table, numerical values of foamability indicate relative values to the results of Comparative Example 1 as 100.

### [Experimental Example 2] Study on Improving Effect on Foamability and Dispersion Stability of Oat Milk by Enzyme Addition

### (Production of Oat Milks of Examples 17 to 28)

Oat milk powder (trade name: Oat Milk Powder GD-F, Godo Co., Ltd.) was mixed with water to obtain a 20 w/w % oat milk powder suspension. To the obtained suspension was added α-amylase (trade name: Spitase CP-40FG, Nagase ChemteX Corporation) at 170 U/g of starch, and β-amylase (trade name: β-Amylase-F ‘Amano’, Amano Enzyme Inc.) was added at 0.09 U/g of starch, and the mixture was reacted at 60° C. for 1 hr. After completion of the reaction, the pH of the reaction solution was adjusted to 8 using tripotassium phosphate. Thereafter, each enzyme listed in Tables 6 and 7 was added at the concentrations listed in Tables 6 and 7, and the mixture was reacted at 60° C. for 1 hr. After completion of the reaction, the mixture was heated at 95° C. for 10 min and then cooled. The cooled suspension was centrifuged at 1000 G/1 min to separate the solid from the liquid, and only the liquid was recovered. The pH was adjusted to 7.5 using tripotassium phosphate, and the oat milks of Examples 17 to 28 were obtained.

### (Production of Oat Milk of Comparative Example 2)

The oat milk of Comparative Example 2 was obtained in the same manner as in Examples 17 to 28, except that the enzymes shown in Tables 6 and 7 were not added.

For Examples 17 to 28 and Comparative Example 2, the total amount of tripotassium phosphate used for the above-mentioned pH adjustment is shown in Tables 6 and 7.

### (Confirmation of Foamability of Oat Milk)

### (Test Method)

The oat milks obtained in Examples 17 to 28, Comparative Example 2 were heated to 60° C., and 30 g was weighed and poured into a milk foamer (trade name: Milk Cup Foamer MCF30W, UCC Ueshima Coffee Co., Ltd.). It was foamed for 1 min to create air bubbles.

Immediately after foaming was completed, the entire amount, including the foam and liquid oat milk, was added to a glass cup containing 70 g of coffee, forming a foam layer of oat milk on top of the liquid layer consisting of a mixture of coffee and liquid oat milk. The height of the entire amount (i.e., from the bottom of the liquid layer to the top of the foam layer (Y in The FIGURE)) and the height of the foam layer (i.e., from the boundary between the liquid layer and the foam layer to the top of the foam layer (X in The FIGURE)) were measured, and the ratio of the foam layer was calculated according to the following formula. The foamability evaluation for each Example is shown in Table 8 as a relative value, when the ratio of the foam layer in Comparative Example 2 was set to 100.

### (Formula for Calculating Ratio of Foam Layer)

$$Ratio of foam layer = height of foam layer ( X ) / height of entire amount ( Y )$$

### (Confirmation of Dispersion Stability of Oat Milk)

The oat milk samples obtained in Examples 17-28 and Comparative Example 2 were weighed (15 ml) into vials, and dispersion stability was evaluated using a high-performance liquid dispersion stability evaluation device (Turbiscan Lab (trade name), Sanyo Trading Co., Ltd.).

According to the operating procedures of the device, scan data for each sample was obtained immediately after completion of the oat milk (0 hr), and 1, 2, and 3 hr later. The Turbiscan Stability Index (TSI), which indicates dispersion stability, was calculated using software analysis of the device. A higher TSI value indicates greater instability.

The evaluation of the dispersion stability of each Example is shown in Table 8 as a relative value to the TSI value for Comparative Example 2 set as 100.

TABLE 6
blended amount (wt/wt %)

| | | Comp. | | | | | | |
|---|---|---|---|---|---|---|---|---|
| | | Ex. | Ex. | Ex. | Ex. | Ex. | Ex. | Ex. |
| | | 2 | 17 | 18 | 19 | 20 | 21 | 22 |
| enzyme | protease | | 0.00001 | | | | | |
| | (Protin SD- | | | | | | | |
| | NY10) | | | | | | | |
| | protease | | | 0.001 | | | | |
| | (Formea CTL | | | | | | | |
| | 300 BG) | | | | | | | |
| | lipase (Lipase | | | | 0.002 | | | |
| | AY ‘Amano’ | | | | | | | |
| | 30SD) | | | | | | | |
| | trans- | | | | | 0.0001 | | |
| | glutaminase | | | | | | | |
| | (Activa TG) | | | | | | | |
| | phospholipase | | | | | | 0.0002 | |
| | (PLA2 NAGASE | | | | | | | |
| | 10P/R) | | | | | | | |
| | cellulase | | | | | | | 0.00001 |
| | (Cellulase A | | | | | | | |
| | ‘Amano’ 3) | | | | | | | |
| alkali | tripotassium | 0.1 | 0.1 | 0.1 | 0.1 | 0.1 | 0.1 | 0.1 |
| metal | phosphate | | | | | | | |
| salt | | | | | | | | |

In Table, numerical values indicate wt/wt % to the total weight of the system (oat milk powder + dissolution water).

TABLE 7
blended amount (wt/wt %)

| | | Ex. | Ex. | Ex. | Ex. | Ex. | Ex. |
|---|---|---|---|---|---|---|---|
| | | 23 | 24 | 25 | 26 | 27 | 28 |
| enzyme | protease (Protin | | | | | | |
| | SD-NY10) | | | | | | |
| | protease (Formea | 0.001 | | | | | |
| | CTL 300 BG) | | | | | | |
| | lipase (Lipase AY | 0.002 | 0.002 | 0.002 | | | |
| | ‘Amano’ 30SD) | | | | | | |
| | transglutaminase | | 0.003 | 0.001 | 0.002 | 0.004 | |
| | (Activa TG) | | | | | | |
| | phospholipase | | | | 0.002 | | 0.002 |
| | (PLA2 NAGASE | | | | | | |
| | 10P/R) | | | | | | |
| | cellulase | | | | | 0.00001 | 0.00001 |
| | (Cellulase A | | | | | | |
| | ‘Amano’ 3) | | | | | | |
| alkali | tripotassium | 0.1 | 0.1 | 0.1 | 0.1 | 0.1 | 0.1 |
| metal | phosphate | | | | | | |
| salt | | | | | | | |

In Table, numerical values indicate wt/wt % to the total weight of the system (oat milk powder + dissolution water).

TABLE 8

| | Comp. | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|
| | Ex. 2 | 17 | 18 | 19 | 20 | 21 | 22 | 23 | 24 | 25 | 26 | 27 | 28 |
| foamability | 100 | 111.8 | 125.7 | 111.8 | 111.8 | 106 | 111.8 | 136.7 | 117.4 | 106 | 106 | 111.8 | 123 |
| (*1) | | | | | | | | | | | | | |
| dispersion | 100 | 101.7 | 83.2 | 74.2 | 100.6 | 94 | 100 | 78.3 | 100.2 | 23.6 | 54.6 | 48.7 | 171.1 |
| stability | | | | | | | | | | | | | |
| (*2) | | | | | | | | | | | | | |

(*1): Numerical values of foamability indicate relative values to the results of Comparative Example 2 as 100.
(*2): Numerical values of dispersion stability indicate relative values to the results (TSI value) of Comparative Example 2 as 100.

### [Experimental Example 3] Study on Improving Effect on Foamability by Addition of Enzyme and Alkali Metal Salt in Combination

### (Production of Oat Milks of Examples 29 to 31)

Whole oat flour (trade name “Oat Flour”, manufactured in Denmark by Sansho Co., Ltd.) was pulverized in a mill and mixed with water to obtain an 11 w/w % oat milk powder suspension. To the obtained suspension was added α-amylase (trade name: Spitase CP-40FG, Nagase ChemteX Corporation) at 170 U/g of starch, and β-amylase (trade name: β-Amylase-F ‘Amano’, Amano Enzyme Inc.) was added at 0.09 U/g of starch, and the mixture was reacted at 60° C. for 1 hr. After completion of the reaction, the pH of the reaction solution was adjusted to 8 using tripotassium phosphate. Thereafter, each enzyme listed in Table 9 was added at the concentrations listed in Table 9, and the mixture was reacted at 60° C. for 1 hr. After completion of the reaction, the mixture was heated at 95° C. for 10 min and then cooled. The cooled suspension was centrifuged at 1000 G/1 min to separate the solid from the liquid, and only the liquid was recovered. The pH was adjusted to 7.5 using tripotassium phosphate, and the oat milks of Examples 29 to 31 were obtained. The total amount of tripotassium phosphate used for the above-mentioned pH adjustment is shown in Table 9.

### (Production of Oat Milk of Comparative Example 3)

The oat milk of Comparative Example 3 was obtained in the same manner as in Examples 29 to 31, except that the enzymes shown in Table 9 were not added, “adjusting the pH to 8 using tripotassium phosphate” was changed to “adjusting the pH to 8 using sodium hydroxide”, and “adjusting the pH to 7.5 using tripotassium phosphate” was changed to “adjusting the pH to 7.5 using sodium hydroxide”. The total amount of sodium hydroxide used for the above-mentioned pH adjustment is shown in Table 9.

### (Production of Oat Milk of Reference Example 1)

The oat milk of Reference Example 1 was obtained in the same manner as in Examples 29 to 31, except that the enzymes shown in Table 9 were not added.

### (Confirmation of Foamability of Oat Milk)

### (Test Method)

The oat milks obtained in Examples 29 to 31, Comparative Example 3, Reference Example 1 were heated to 60° C., and 30 g was weighed and poured into a milk foamer (trade name: Milk Cup Foamer MCF30W, UCC Ueshima Coffee Co., Ltd.). It was foamed for 1 min to create air bubbles.

Immediately after foaming was completed, the entire amount, including the foam and liquid oat milk, was added to a glass cup containing 70 g of coffee, forming a foam layer of oat milk on top of the liquid layer consisting of a mixture of coffee and liquid oat milk. The height of the entire amount (i.e., from the bottom of the liquid layer to the top of the foam layer (Y in The FIGURE)) and the height of the foam layer (i.e., from the boundary between the liquid layer and the foam layer to the top of the foam layer (X in The FIGURE)) were measured, and the ratio of the foam layer was calculated according to the following formula. The foamability evaluation for each Example is shown in Table 10 as a relative value, when the ratio of the foam layer in Comparative Example 3 was set to 100.

### (Formula for Calculating Ratio of Foam Layer)

$$Ratio of foam layer = height of foam layer ( X ) / height of entire amount ( Y )$$

TABLE 9
blended amount (wt/wt %)

| Comp. | Ref. | | | |
|---|---|---|---|---|
| Ex. | Ex. | Ex. | Ex. | Ex. |
| 3 | 1 | 29 | 30 | 31 |

| | | | | | |
|---|---|---|---|---|---|
| enzyme | protease (Protin SD- | | 0.00001 | | |
| | AY10) | | | | |
| | lipase (Lipase MHA | | | 0.0008 | |
| | ‘Amano’ 10SD) | | | | |
| | protease (Formea CTL | | | | 0.0004 |
| | 300 BG) | | | | |
| alkali | tripotassium | 0.06 | 0.06 | 0.06 | 0.06 |
| metal | phosphate | | | | |
| salt | | | | | |

| | |
|---|---|
| 0.1M sodium hydroxide | 0.08 |

In Table, numerical values indicate wt/wt % to the total weight of the system (oat flour + dissolution water).

TABLE 10

| | Comp. Ex. 3 | Ref. Ex. 1 | Ex. 29 | Ex. 30 | Ex. 31 |
|---|---|---|---|---|---|
| foamability | 100 | 116 | 130 | 144 | 150.5 |
| (*1) | | | | | |

(*1): Numerical values of foamability indicate relative values to the results of Comparative Example 3 as 100.

### [Experimental Example 4] Study on Improving Effect on Foamability by Addition of Enzyme and Alkali Metal Salt in Combination

### (Production of Oat Milks of Examples 32 to 50)

Whole oat flour (trade name “Oat Flour”, manufactured in Denmark by Sansho Co., Ltd.) was pulverized in a mill and mixed with water to obtain an 11 w/w % oat milk powder suspension. To the obtained suspension was added α-amylase (trade name: Spitase CP-40FG, Nagase ChemteX Corporation) at 170 U/g of starch, and β-amylase (trade name: β-Amylase-F ‘Amano’, Amano Enzyme Inc.) was added at 0.09 U/g of starch, and the mixture was reacted at 60° C. for 1 hr. After completion of the reaction, the pH of the reaction solution was adjusted to 8 using tripotassium phosphate. Thereafter, each enzyme listed in Tables 11 to 13 was added at the concentrations listed in Tables 11 to 13, and the mixture was reacted at 60° C. for 1 hr. After completion of the reaction, the mixture was heated at 95° C. for 10 min and then cooled. The cooled suspension was centrifuged at 1000 G/1 min to separate the solid from the liquid, and only the liquid was recovered. The pH was adjusted to 7.5 using tripotassium phosphate, and the oat milks of Examples 32 to 50 were obtained. The total amount of tripotassium phosphate used for the above-mentioned pH adjustment is shown in Tables 11 to 13.

### (Production of Oat Milk of Comparative Example 4)

The oat milk of Comparative Example 4 was obtained in the same manner as in Examples 32 to 50, except that the enzymes shown in Tables 11 to 13 were not added, “adjusting the pH to 8 using tripotassium phosphate” was changed to “adjusting the pH to 8 using sodium hydroxide”, and “adjusting the pH to 7.5 using tripotassium phosphate” was changed to “adjusting the pH to 7.5 using sodium hydroxide”. The total amount of sodium hydroxide used for the above-mentioned pH adjustment is shown in Table 11.

### (Production of Oat Milk of Reference Example 2)

The oat milk of Reference Example 2 was obtained in the same manner as in Examples 32 to 50, except that the enzymes shown in Tables 11 to 13 were not added.

### (Confirmation of Foamability of Oat Milk)

### (Test Method)

The oat milks obtained in Examples 32 to 50, Comparative Example 4, Reference Example 2 were weighed by 30 g, poured into a milk foamer (trade name: Milk Cup Foamer MCF30W, UCC Ueshima Coffee Co., Ltd.), and foamed for 1 min on Hot mode to create air bubbles.

Immediately after foaming was completed, the entire amount, including the foam and liquid oat milk, was added to a glass cup containing 70 g of coffee, forming a foam layer of oat milk on top of the liquid layer consisting of a mixture of coffee and liquid oat milk. The height of the entire amount (i.e., from the bottom of the liquid layer to the top of the foam layer (Y in The FIGURE)) and the height of the foam layer (i.e., from the boundary between the liquid layer and the foam layer to the top of the foam layer (X in The FIGURE)) were measured, and the ratio of the foam layer was calculated according to the following formula. The foamability evaluation for each Example is shown in Tables 14 to 16 as a relative value, when the ratio of the foam layer in Comparative Example 4 was set to 100.

### (Formula for Calculating Ratio of Foam Layer)

$$Ratio of foam layer = height of foam layer ( X ) / height of entire amount ( Y )$$

TABLE 11
blended amount (wt/wt %)

| Comp. | Ref. | | | | | |
|---|---|---|---|---|---|---|
| Ex. | Ex. | Ex. | Ex. | Ex. | Ex. | Ex. |
| 4 | 2 | 32 | 33 | 34 | 35 | 36 |

| | | | | | | | |
|---|---|---|---|---|---|---|---|
| enzyme | pectinase | | 0.008 | | 0.00008 | 0.0008 | 0.008 |
| | (Pectinase XP-534 | | | | | | |
| | NEO) | | | | | | |
| | glucose oxidase | | | 0.00008 | | | |
| | (Sumizyme PGO) | | | | | | |
| | lipase (Lipase MHA) | | | | 0.0008 | | |
| | cellulase | | | | | 0.00002 | |
| | (Cellulase A | | | | | | |
| | ‘Amano’ 3) | | | | | | |
| | hemicellulase | | | | | | 0.002 |
| | (Hemicellulase | | | | | | |
| | ‘Amano’ 90) | | | | | | |
| alkali | tripotassium | 0.09 | 0.06 | 0.09 | 0.09 | 0.09 | 0.09 |
| metal | phosphate | | | | | | |
| salt | | | | | | | |

| | |
|---|---|
| 1M sodium hydroxide | 0.02 |

In Table, numerical values indicate wt/wt % to the total weight of the system (oat flour + dissolution water).

TABLE 12
blended amount (wt/wt %)

| | | Ex. | Ex. | Ex. | Ex. | Ex. | Ex. | Ex. |
|---|---|---|---|---|---|---|---|---|
| | | 37 | 38 | 39 | 40 | 41 | 42 | 43 |
| enzyme | pectinase (Pectinase | 0.008 | 0.008 | | | | | |
| | XP-534 NEO) | | | | | | | |
| | glucose oxidase | | | 0.00008 | 0.00008 | 0.00008 | 0.00008 | 0.00008 |
| | (Sumizyme PGO) | | | | | | | |
| | lipase (Lipase MHA) | | | 0.0008 | | | | |
| | cellulase (Cellulase | | | | 0.002 | | | |
| | A ‘Amano’ 3) | | | | | | | |
| | hemicellulase | | | | | 0.0002 | | |
| | (Hemicellulase | | | | | | | |
| | ‘Amano’ 90) | | | | | | | |
| | transglutaminase | 0.002 | | | | | 0.002 | |
| | (Activa TG) | | | | | | | |
| | phospholipase (PLA2 | | 0.002 | | | | | 0.002 |
| | NAGASE 10P/R) | | | | | | | |
| alkali | tripotassium | 0.09 | 0.09 | 0.09 | 0.09 | 0.09 | 0.09 | 0.09 |
| metal | phosphate | | | | | | | |
| salt | | | | | | | | |

In Table, numerical values indicate wt/wt % to the total weight of the system (oat flour + dissolution water).

TABLE 13
blended amount (wt/wt %)

| | | Ex. | Ex. | Ex. | Ex. | Ex. | Ex. | Ex. |
|---|---|---|---|---|---|---|---|---|
| | | 44 | 45 | 46 | 47 | 48 | 49 | 50 |
| enzyme | pectinase | 0.0008 | | | 0.0008 | 0.0008 | | |
| | (Pectinase | | | | | | | |
| | XP-534 NEO) | | | | | | | |
| | pectinase | | | | | | 0.0008 | 0.0008 |
| | (Sumizyme | | | | | | | |
| | AP2) | | | | | | | |
| | glucose | | 0.00008 | | | | | |
| | oxidase | | | | | | | |
| | (Sumizyme | | | | | | | |
| | PGO) | | | | | | | |
| | lipase | | | 0.0008 | 0.00008 | | | |
| | (Lipase MHA) | | | | | | | |
| | transglutaminase | | | | | 0.0002 | | |
| | (Activa TG) | | | | | | | |
| | protease | 0.00008 | | 0.0004 | 0.00008 | 0.00008 | | |
| | (Formea CTL | | | | | | | |
| | 300 BG) | | | | | | | |
| | protease | | 0.00008 | 0.00008 | | | | 0.0002 |
| | (Protin SD- | | | | | | | |
| | AY10) | | | | | | | |
| alkali | tripotassium | 0.09 | 0.09 | 0.09 | 0.09 | 0.09 | 0.09 | 0.09 |
| metal | phosphate | | | | | | | |
| salt | | | | | | | | |

In Table, numerical values indicate wt/wt % to the total weight of the system (oat flour + dissolution water).

TABLE 14

| | Comp. | Ref. | | | | | |
|---|---|---|---|---|---|---|---|
| | Ex. | Ex. | Ex. | Ex. | Ex. | Ex. | Ex. |
| | 4 | 2 | 32 | 33 | 34 | 35 | 36 |
| foamability | 100 | 165.4 | 217.4 | 227 | 232 | 236.8 | 236.8 |
| (*1) | | | | | | | |

(*1): Numerical values of foamability indicate relative values to the results of Comparative Example 4 as 100.

TABLE 15

| | Ex. | Ex. | Ex. | Ex. | Ex. | Ex. | Ex. |
|---|---|---|---|---|---|---|---|
| | 37 | 38 | 39 | 40 | 41 | 42 | 43 |
| foamability | 221 | 236.8 | 232 | 236.8 | 236.8 | 224 | 236.8 |
| (*1) | | | | | | | |

(*1): Numerical values of foamability indicate relative values to the results of Comparative Example 4 as 100.

TABLE 16

| | Ex. | Ex. | Ex. | Ex. | Ex. | Ex. | Ex. |
|---|---|---|---|---|---|---|---|
| | 44 | 45 | 46 | 47 | 48 | 49 | 50 |
| foamability | 252.2 | 239.7 | 236.8 | 259.6 | 241.1 | 218.8 | 231 |
| (*1) | | | | | | | |

(*1): Numerical values of foamability indicate relative values to the results of Comparative Example 4 as 100.

### INDUSTRIAL APPLICABILITY

According to the present invention, oat milk that can prepare foamed milk having a sufficient amount of air bubbles can be produced.

This application is based on a patent application No. 2023-056388 filed in Japan (filing date: Mar. 30, 2023), the contents of which are incorporated in full herein.

1. A method for producing plant-derived milk, comprising treating a raw material containing a plant-derived protein with two or more types of enzymes selected from the group consisting of the following (1) to (6):
(1) lipase
(2) glucose oxidase
(3) cell wall degrading enzyme
(4) protease
(5) transglutaminase
(6) phospholipase.

2. The production method according to claim 1, wherein the two or more types of enzymes selected from the group consisting of the aforementioned (1) to (6) are selected from the group consisting of the following (i) to (xx):
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase.

3. The production method according to claim 1, wherein the raw material containing a plant-derived protein is a raw material oat, and the plant-derived milk is oat milk.

4. The production method according to claim 1, wherein the protease is an endo-type protease.

5. The production method according to claim 1, wherein the lipase is a lipase that acts on one or two coordination sites of triglyceride.

6. The production method according to claim 1, wherein the phospholipase is phospholipase A.

7. The production method according to claim 1, wherein the cell wall degrading enzyme is one or more types selected from the group consisting of pectinase, cellulase, and hemicellulase.

8. The production method according to claim 1, further comprising treating with an alkali metal salt.

9. The production method according to claim 8, wherein the alkali metal salt is tripotassium phosphate.

10. A method for producing plant-derived milk, comprising treating a raw material containing a plant-derived protein with one or more types of enzymes selected from the group consisting of the following (1) to (6) and an alkali metal salt:
(1) lipase
(2) glucose oxidase
(3) cell wall degrading enzyme
(4) protease
(5) transglutaminase
(6) phospholipase.

11. The production method according to claim 10, wherein the one or more types of enzymes selected from the group consisting of the aforementioned (1) to (6) are selected from the group consisting of the following (I) to (VI) and (i) to (xx):
(I) lipase
(II) glucose oxidase
(III) cell wall degrading enzyme
(IV) protease
(V) transglutaminase
(VI) phospholipase
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase.

12. The production method according to claim 10, wherein the raw material containing a plant-derived protein is a raw material oat, and the plant-derived milk is oat milk.

13. The production method according to claim 10, wherein the protease is an endo-type protease.

14. The production method according to claim 10, wherein the lipase is a lipase that acts on one or two coordination sites of triglyceride.

15. The production method according to claim 10, wherein the phospholipase is phospholipase A.

16. The production method according to claim 10, wherein the cell wall degrading enzyme is one or more types selected from the group consisting of pectinase, cellulase, and hemicellulase.

17. The production method according to claim 10, wherein the alkali metal salt is tripotassium phosphate.

18. A method for improving dispersion stability of plant-derived milk during production thereof, comprising treating a raw material containing a plant-derived protein with two or more types of enzymes selected from the group consisting of the following (1) to (6)
(1) lipase
(2) glucose oxidase
(3) cell wall degrading enzyme
(4) protease
(5) transglutaminase
(6) phospholipase.

19. The improving method according to claim 18, wherein the two or more types of enzymes selected from the group consisting of the aforementioned (1) to (6) are selected from the group consisting of the following (i) to (xx):
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase.

20. The improving method according to claim 18, wherein the raw material containing a plant-derived protein is a raw material oat, and the plant-derived milk is oat milk.

21. The improving method according to claim 18, wherein the protease is an endo-type protease.

22. The improving method according to claim 18, wherein the lipase is a lipase that acts on one or two coordination sites of triglyceride.

23. The improving method according to claim 18, wherein the phospholipase is phospholipase A.

24. The improving method according to claim 18, wherein the cell wall degrading enzyme is one or more types selected from the group consisting of pectinase, cellulase, and hemicellulase.

25. The improving method according to claim 18, further comprising treating with an alkali metal salt.

26. The improving method according to claim 25, wherein the alkali metal salt is tripotassium phosphate.

27. A method for improving dispersion stability of plant-derived milk during production thereof, comprising treating a raw material containing a plant-derived protein with one or more types of enzymes selected from the group consisting of the following (1) to (6) and an alkali metal salt:
(1) lipase
(2) glucose oxidase
(3) cell wall degrading enzyme
(4) protease
(5) transglutaminase
(6) phospholipase.

28. The improving method according to claim 27, wherein the one or more types of enzymes selected from the group consisting of the aforementioned (1) to (6) are selected from the group consisting of the following (I) to (VI) and (i) to (xx):
(I) lipase
(II) glucose oxidase
(III) cell wall degrading enzyme
(IV) protease
(V) transglutaminase
(VI) phospholipase
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase.

29. The improving method according to claim 27, wherein the raw material containing a plant-derived protein is a raw material oat, and the plant-derived milk is oat milk.

30. The improving method according to claim 27, wherein the protease is an endo-type protease.

31. The improving method according to claim 27, wherein the lipase is a lipase that acts on one or two coordination sites of triglyceride.

32. The improving method according to claim 27, wherein the phospholipase is phospholipase A.

33. The improving method according to claim 27, wherein the cell wall degrading enzyme is one or more types selected from the group consisting of pectinase, cellulase, and hemicellulase.

34. The improving method according to claim 27, wherein the alkali metal salt is tripotassium phosphate.

35. An enzyme preparation for modifying plant-derived milk or for improving dispersion stability of plant-derived milk during production thereof, the preparation comprising two or more types of enzymes selected from the group consisting of the following (1) to (6):
(1) lipase
(2) glucose oxidase
(3) cell wall degrading enzyme
(4) protease
(5) transglutaminase
(6) phospholipase.

36. The enzyme preparation according to claim 35, wherein the two or more types of enzymes selected from the group consisting of the aforementioned (1) to (6) are selected from the group consisting of the following (i) to (xx):
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase.

37. The enzyme preparation according to claim 35, wherein the plant-derived milk is oat milk.

38. An enzyme preparation for modifying plant-derived milk or for improving dispersion stability of plant-derived milk during production thereof, the preparation comprising one or more types of enzymes selected from the group consisting of the following (1) to (6), and an alkali metal salt:
(1) lipase
(2) glucose oxidase
(3) cell wall degrading enzyme
(4) protease
(5) transglutaminase
(6) phospholipase.

39. The enzyme preparation according to claim 38, wherein the one or more types of enzymes selected from the group consisting of the aforementioned (1) to (6) are selected from the group consisting of the following (I) to (VI) and (i) to (xx):
(I) lipase
(II) glucose oxidase
(III) cell wall degrading enzyme
(IV) protease
(V) transglutaminase
(VI) phospholipase
(i) lipase and glucose oxidase
(ii) lipase and cell wall degrading enzyme
(iii) lipase and protease
(iv) glucose oxidase and protease
(v) cell wall degrading enzyme and protease
(vi) lipase and transglutaminase
(vii) lipase and phospholipase
(viii) glucose oxidase and cell wall degrading enzyme
(ix) glucose oxidase and transglutaminase
(x) glucose oxidase and phospholipase
(xi) two types of cell wall degrading enzymes
(xii) cell wall degrading enzyme and transglutaminase
(xiii) cell wall degrading enzyme and phospholipase
(xiv) two types of proteases
(xv) protease and phospholipase
(xvi) protease and transglutaminase
(xvii) transglutaminase and phospholipase
(xviii) lipase, cell wall degrading enzyme, and protease
(xix) lipase and two types of proteases
(xx) cell wall degrading enzyme, protease, and transglutaminase.

40. The enzyme preparation according to claim 38, wherein the plant-derived milk is oat milk.
